(19) United States
(12) Patent Application Publication
(10) Pub. No.: US 2026/0009694 A1
(43) Pub. Date: Jan. 8, 2026

(54) METHOD AND SYSTEM FOR MONITORING BRIDGE PIERS BASED ON DIGITAL TWIN, AND FLOW-INDUCED VIBRATION PROTECTION DEVICE

(71) Applicant: SHANDONG UNIVERSITY, Jinan (CN)

(72) Inventors: Zeying YANG, Jinan (CN); Bo HAN, Jinan (CN); Mei LIU, Jinan (CN); Rongjiang PAN, Jinan (CN); Chuanlong BI, Jinan (CN); Weisong QU, Jinan (CN); Chenchen FANG, Jinan (CN); Chuanhao SHAN, Jinan (CN); Jianbo QU, Jinan (CN); Xue ZHANG, Jinan (CN); Hongye XUE, Jinan (CN); Rui SUN, Jinan (CN); Rongrong DUAN, Jinan (CN); Zhilin QU, Jinan (CN)

(21) Appl. No.: 19/237,347

(22) Filed: Jun. 13, 2025

(30) Foreign Application Priority Data
Jul. 8, 2024 (CN) 2024109028487

(51) Int. Cl. G01M 5/00; G01M 7/02

(52) U.S. Cl. CPC G01M 5/0008; G01M 7/025

(57) ABSTRACT

The present invention belongs to the technical field of bridge protection. In order to solve the problem of how to protect bridge piers from flow-induced vibration (FIV), the present invention provides a method and system for monitoring the bridge piers based on digital twin and a FIV protection device, comprising: an annular steel board and multiple polyurethane boards, an inner wall of the annular steel board is fixedly connected to a structure to be protected, hydraulic devices and multiple energy-dissipation springs are arranged between an outer wall of the annular steel board and the polyurethane boards, and the polyurethane boards are spaced apart. The present invention may reduce or even eliminate the FIV caused by seawater or rivers to the structure to be protected, thereby slowing down the fatigue damage caused by FIV to the structure to be protected.

### CROSS-REFERENCE TO RELATED APPLICATIONS

The present invention claims priority benefits to Chinese Patent Application number 202410902848.7, entitled “A Method and System for Monitoring Bridge Piers Based on Digital Twin, and A Flow-Induced Vibration Protection Device”, filed on Jul. 8, 2024, with the China National Intellectual Property Office, the entire contents of which are incorporated herein by reference and constitute a part of the present invention for all purposes.

### TECHNICAL FIELD

The present invention belongs to the technical field of bridge protection, and particularly relates to a method and system for monitoring bridge piers based on digital twin and a flow-induced vibration protection device.

### BACKGROUND

The statements in this section merely provide background information related to the present invention and do not necessarily constitute prior art.

There are many cases both domestically and internationally where the complex pulsation and fluctuation of seawater can easily induce vibration and damage to structures (such as bridge piers) in seawater. One of the reasons for this is not only the lack of attention, but also the absence of effective flow-induced vibration protection devices for this part of the structure.

Flow-induced vibration (FIV) is a resonance phenomenon of structures under continuous wave excitation. The vibration is influenced by both flow excitation and internal factors of bridge pier structure. Because the bridge pier structure constitutes a low damping system, the resonance phenomenon will continue to exist during the service life of the bridge. As ocean waves advance, the fluid may excite large vibrations of bridge piers, such as flutter, threatening the safety of the structure. Flutter is a kind of self-excited vibration phenomenon produced by fluid-structure coupling system itself. Fluid excites the bridge pier structure to vibrate, and the vibration will disturb flow field and change load distribution characteristics. If the changing fluid load just plays a negative damping effect on the bridge pier, the fluid will not contribute to the stability of the structure. At this time, the system will continue to obtain energy from the fluid, and the unstable phenomenon of amplitude gradually expanding will occur, which will eventually cause structural failure. It is a dangerous situation that needs to be avoided. During the service of large bridges at sea, the bridge pier structures are subjected to frequent fatigue loads, and the contribution rate of FIV to the total accumulated fatigue damage reaches 50%.

Therefore, how to protect the bridge pier from FIV and timely sense the relevant protection conditions of the bridge pier, so as to reduce the fatigue load caused by FIV on the bridge pier and eliminate the risk of resonance of the bridge pier, are the problems to be solved at present.

### SUMMARY

To overcome the defects of the prior art, the present invention provides method and system for monitoring bridge piers based on digital twin and a FIV protection device, which can reduce or even eliminate the FIV generated by seawater or river to a structure to be protected, so as to alleviate fatigue damage generated by the FIV to the structure to be protected.

In order to achieve the above objects, a first aspect of the present invention provides a FIV protection device, comprising an annular steel board and a plurality of polyurethane boards, wherein an inner wall of the annular steel board is fixedly connected to a structure to be protected, a hydraulic device and a plurality of energy-dissipation springs are arranged between an outer wall of the annular steel board and each of the plurality of the polyurethane boards, and the plurality of the polyurethane boards are arranged at intervals.

A second aspect of the present invention provides a method for monitoring bridge piers based on digital twin, adopting a FIV protection device described above, the method comprising:
acquiring state parameters of the FIV protection device; wherein, the state parameters comprise magnitude and direction of displacement, force situation and acceleration; and
judging whether to adjust or replace the FIV protection device according to the acquired state parameters of the FIV protection device.

A third aspect of the present invention provides a system for monitoring bridge piers based on digital twin, comprising:
an acquisition module, configured to: acquire state parameters of a FIV protection device, wherein the state parameters comprise magnitude and direction of displacement, force situation and acceleration; and
a judgment module, configured to: judge whether to adjust or replace the FIV protection device according to the acquired state parameters of the FIV protection device.

One or more of the above technical solutions have the following beneficial effects:

According to the present invention, the FIV protection device can reduce or even eliminate the FIV generated by seawater or river to the structure to be protected, so as to alleviate the fatigue damage generated by the FIV to the structure to be protected. Due to the arrangement of polyurethane boards, different polyurethane boards are retracted or extended under the action of water flow, which disturbs the FIV generated by water flow to the bridge pier, and can effectively avoid the resonance between the structure to be protected and the water flow and thus damage. In addition, the polyurethane boards can also increase damping with the functions of energy-dissipation springs and hydraulic devices to reduce the direct effect of water flow on the structure to be protected, thereby reducing the fatigue load caused by the FIV on the structure to be protected and avoiding the resonance damage to the structure to be protected, and the passive protective function is performed.

According to the present invention, addressing the problem that fluid force is difficult to detect, the state parameters of the FIV protection device are acquired, namely the magnitude and direction of displacement of the hydraulic device and force situation of the polyurethane boards, then a plurality of groups of mapping data are obtained based on digital twin simulation, and then surrogate models are trained through the mapping data to obtain trained surrogate models; the trained surrogate model can be used to monitor the stress of bridge piers, and the protection situations of FIV protection devices can be judged timely and effectively. When the FIV protection devices do not play a relevant role for protection, early warning and replacement can be carried out in time, or the user will be notified to take measures such as the reinforcement by using carbon fiber boards.

According to the present invention, time-history curve of the acceleration of the FIV protection device is acquired and processed by fast Fourier transform to obtain the power spectrum; the power spectrum is input into the digital twin process system for bridge-pier FIV protection, natural vibration frequencies of the structure to be protected under a dry mode and a wet mode are calculated respectively according to a digital twin-body of the structure to be protected by the digital twin model, and is compared with the power spectrum, to analyze whether the structure to be protected generates random resonance with water flow, which may judge whether the flow induced vibration protection device needs to be adjusted timely and effectively, and protection operations on the structure to be protected are carried out according to the comparison result, to reduce the fatigue damage of the bridge piers under the action of water flow, and avoid the danger of resonance between bridge piers and water flow.

Advantages of additional aspects of the invention will be set forth in part in the following description, and in part will become apparent from the following description, or may be learned by practice of the present invention.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a partial top view of a FIV protection device of a bridge pier according to Example 1 of the present invention.

FIG. 2 is another partial top view of the FIV protection device of the bridge pier according to Example 1 of the present invention.

FIG. 3 is an enlarged view of details of energy-dissipation springs according to Example 1 of the present invention.

FIG. 4 is an enlarged view of details of a hydraulic-rod power generation module according to Example 1 of the present invention.

FIG. 5 is an enlarged view of details of an acceleration-sensor and an integration module according to Example 1 of the present invention.

FIG. 6 is a flow chart of a method for preventing flow-induced vibration according to Example 2 of the present invention.

In the drawings: 1, joint of steel boards; 2, polyurethane board; 3, energy-dissipation spring; 4, hydraulic rod; 5, integration module; 6, acceleration sensor; 61, processor module; 62, wireless data-transmission module; 63, data-storage module; 64, battery module; 41, transmission rack; 42, electric generator; and, 43, transmission gear.

### DETAILED DESCRIPTION

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention.

The examples and the features of the examples in the present invention may be combined with each other without conflict.

### Example 1

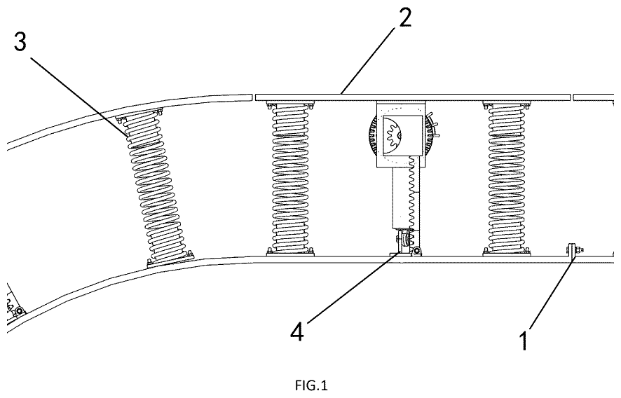

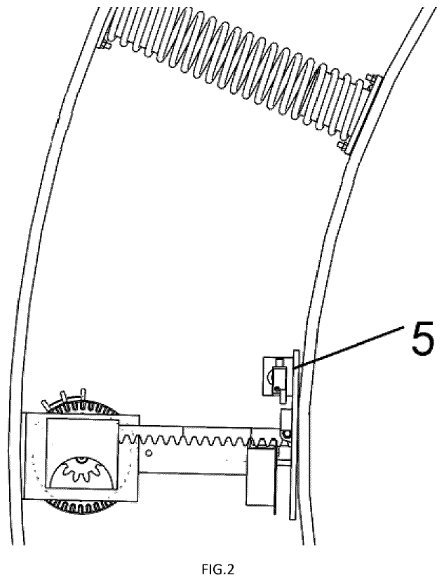

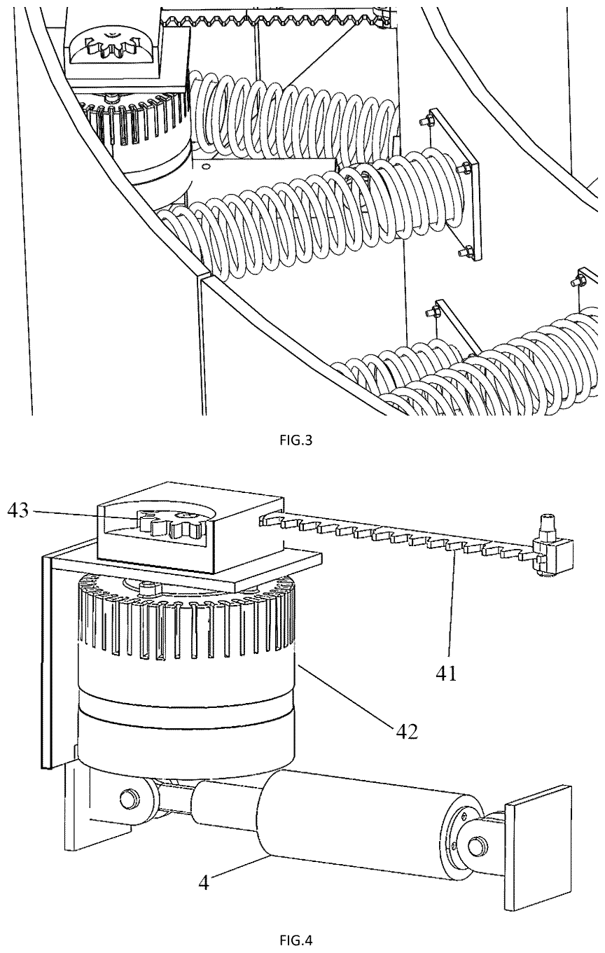

As shown in FIGS. 1-2, the object of the present example is to provide a FIV protection device, comprising an annular steel board and a plurality of polyurethane boards 2, wherein an inner wall of the annular steel board is fixedly connected to a structure to be protected, a hydraulic device and a plurality of energy-dissipation springs 3 are arranged between an outer wall of the annular steel board and each of the plurality of the polyurethane boards 2, and the plurality of the polyurethane boards 2 are arranged at intervals.

The FIV protection device provided in the present example can reduce or even eliminate the FIV generated by seawater or river to the structure to be protected, so as to alleviate the fatigue damage generated by the FIV to the structure to be protected. Different polyurethane boards are retracted or extended under the action of water flow, disturbing the FIV of the bridge pier caused by water flow, which can effectively avoid the resonance between the structure to be protected, and the water flow and thus damage. In addition, the polyurethane boards can also increase damping with the help of the energy-dissipation springs and the hydraulic devices, reduce the direct effect of water flow on the structure to be protected, thus reducing the fatigue load caused by the FIV to the structure to be protected, avoiding resonance damage caused by the FIV, and exerting passive protection function.

The structure to be protected in the present example may be a bridge, or other structures requiring protection against the FIV. In the present example, the bridge is taken as an example to describe the protection device in detail below.

In the present example, the FIV protection device is placed on each of the bridge piers, and the FIV protection device further comprises an acceleration-sensor module, a processor module, a battery module, a power generation module, a wireless data-transmission module, a data-storage module and a FIV energy-dissipation module, which are seven main modules in total.

Wherein, the acceleration-sensor module comprises two acceleration sensors 6, i.e., a first acceleration sensor and a second acceleration sensor, wherein the first acceleration sensor and the second acceleration sensor are arranged on the annular steel board and are oppositely arranged on a horizontal plane.

In the present example, the FIV energy-dissipation module mainly comprises ocean-grade polyurethane boards 2, hydraulic devices, energy-dissipation springs 3, steel boards and integrated modules 5. Wherein, the hydraulic devices specifically are of hydraulic rods 4.

The FIV energy-dissipation module comprises two or a plurality of the steel boards, wherein the plurality of the steel boards form the annular steel board; the joints 1 of adjacent steel boards are connected by bolts; the inner wall of the annular steel board is fixed on the bridge pier; the energy-dissipation springs 3 and the hydraulic rods 4 are fixed on the outer wall of the annular steel board; and, different numbers of the energy-dissipation springs are provided according to different sizes of the bridge piers.

Specifically, one end of the energy-dissipation spring 3 is fixed on the outer wall of the annular steel board, another end of the energy-dissipation spring 3 is fixed on the polyurethane board 2; each of the plurality of the polyurethane board 2 is connected with a plurality of the energy-dissipation springs 3 and one the hydraulic rod 4; an hydraulic cylinder end of the hydraulic rod 4 is connected to the steel board, and another end of the hydraulic rod 4 is connected to the polyurethane board 2; as shown in FIG. 2, the hydraulic rod 4 is arranged in a middle position of each the polyurethane board 2. Wherein, the adjacent polyurethane boards 2 are not directly connected.

The first acceleration sensor and the second acceleration sensor are respectively arranged on steel boards on opposite sides of the bridge pier, and the integration module 5 is respectively arranged at one end of the first acceleration sensor and one end of the second acceleration sensor; as shown in FIG. 5, the integration module 5 comprises the processor module 61, the wireless data-transmission module 62, the data-storage module 63 and the battery module 64.

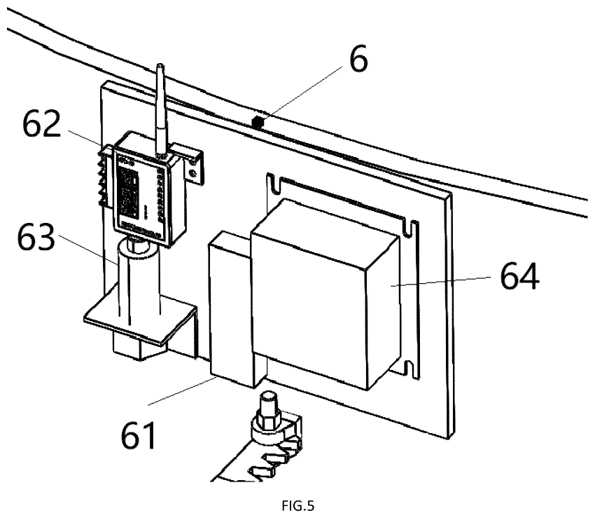

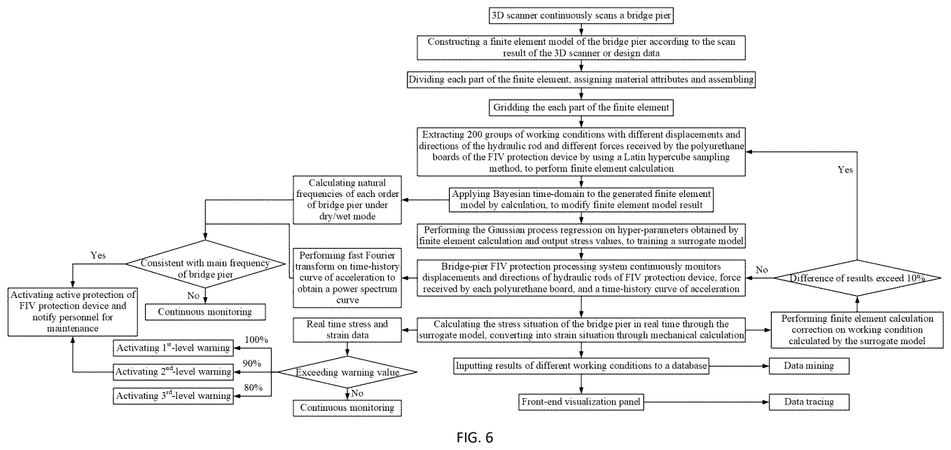

As shown in FIG. 4, the power generation module is provided on the hydraulic rod 4, and the power generation module comprises a transmission rack 41 and a electric generator 42. The electric generator 42 and the transmission rack 41 are respectively fixed at two ends of the hydraulic rod 4 through a collar, and when the hydraulic rod 4 moves, the transmission gear 43 on the electric generator moves relative to the transmission rack 41, and the electric generator generates electricity.

### Example 2

The present example discloses a FIV protection method, which uses the FIV protection device of Example 1, and specifically comprising:
Step 1: acquiring state parameters of the FIV protection device, wherein the state parameters comprise magnitude and direction of displacement, force situation and acceleration;
Step 2, judging whether to adjust or replace the FIV protection device according to the acquired state parameters of the FIV protection device.

In the present example, judging whether to adjust the FIV protection device according to the acquired state parameters of the FIV protection device, specifically comprising the following steps:
Step 2-1: processing acquired state parameter—the acceleration of the FIV protection device by using fast Fourier transform to obtain a power spectrum; and
Step 2-2: inputting the obtained power spectrum into a digital twin process system for bridge-pier FIV protection corresponding to the bridge pier, comparing the power spectrum with natural vibration frequencies calculated under a dry mode and a wet mode respectively through a bridge-pier digital twin-body, obtaining a prediction result of whether the bridge pier generates the FIV, and performing, by the digital twin process system for bridge-pier FIV protection, protection operations on the bridge pier according to the prediction result.

In the present example, the digital twin system is used to monitor the vibration of the bridge piers in real time, and add database with time to optimize the data model. The digital twin system actively adjusts the damping of the FIV protection device. In case of ship collision, the FIV protection device of the bridge pier can be manually adjusted or automatically adjusted to weaken the ship collision load or directly change the ship moving direction.

When a dominant frequency of a fluctuating load of water flow in the ocean is close to a certain natural frequency of the bridge pier, resonance phenomenon will occur, which will affect the safety and stability of the bridge. Therefore, it is necessary to understand the modal characteristics of the bridge pier.

In the present example, finite element modeling is performed on the bridge pier through the digital twin system to obtain the modal characteristics of a partition wall, and the modal characteristics are compared with the obtained spectral characteristics of the bridge pier to analyze whether the bridge pier will generate random resonance with the water flow.

The bridge-pier FIV protection system in the digital twin system can trace and predict the time-history curve of acceleration of a bridge-pier service life cycle. Specifically, fast Fourier transform is performed on the received time-history curve signal of acceleration of the bridge pier to obtain a power spectrum curve of vibration of the bridge pier, thereby obtaining a magnitude of a main frequency of vibration response, wherein, the magnitude of the main frequency is a magnitude of the corresponding frequency when the power spectral density is relatively large, and the main frequency is equal to or more than one; detecting whether there is a vibration response frequency close to or the same as the natural frequency of the bridge pier, and finding resonance hidden dangers in time. The digital twin system can adjust the posture and damping of the bridge pier's FIV protection device automatically, change an additional mass of the bridge pier, and avoid the instability of the bridge pier resonance. For these bridge piers, they are all in the linear elastic phase in the service cycle, and the deformation is very small, only doing small vibration near the equilibrium position, belonging to a constant coefficient linear system. Therefore, the excitation effect of water flow can be regarded as an ergodic stationary random process, so the process can be expressed by the response function of frequency.

In order to analyze the spectrum of signals by using a computer, it is required that the signals analyzed are discrete in time domain and frequency domain, and the discrete signals in time domain and the discrete spectra in frequency domain are finite in length. Discrete Time Fourier Transform (DTFT) for discrete signal, whose time domain signal is discrete aperiodic and whose frequency harmonics are continuous periodic, obviously cannot meet the requirements of spectrum analysis by using the computer. Discrete Fourier Series (DFS) for discrete periodic signal, its spectrum in time domain and frequency domain are discrete periodic changes, and its sustainable interval is infinite, which does not meet the analysis requirements. However, using the periodicity of DFS in time domain and frequency domain, taking one period each, a discrete finite length signal in time domain and a discrete finite spectrum in frequency domain are formed, and a new transform pair can be formed. This transformation pair is known as the Discrete Fourier Transform (DFT).

The frequency-domain power spectrum of the bridge-pier vibration is obtained through the fast Fourier transform, and the magnitude of the main frequency of vibration response is obtained. The main frequency of vibration response is compared with the natural frequencies of the bridge pier under dry and wet modes in real time to judge whether the random resonance between the bridge pier and water flow occurs.

If the main frequencies of fluctuating pressure and vibration response of the bridge pier are far away from the natural frequencies of the bridge pier under the dry and wet modes, random resonance will not occur, so as to monitor the vibration state of the bridge pier.

Through the known engineering conditions, inputting the effect of water flow on bridge piers in dry and wet modes, comprising hydrostatic pressure and pulsating pressure, dry mode and wet mode.

### 1. Calculations of the Dry Mode

A motion equation of a structural system can be expressed in matrix form as:

$$[ M ] \{ \ddot{u} \} + [ C ] \{ \dot{u} \} + [ K ] \{ u \} = \{ p ( t ) \} \qquad ( 1 )$$

Where, [M] is a mass matrix, [K] is a stiffness matrix, [C] is a damping matrix, {ü} is an acceleration vector, {\dot{u}} is a velocity vector, {u} is a displacement vector, and {p(t)} is an external load vector.

For concrete structures, the damping ratio is very small, about 0.05, and the difference between damped and undamped frequencies is not large, so the effect of damping can be ignored, that is, [C] is equal to zero. Letting {p(t)} be equal to zero, and the equation of the free vibration of the system under the condition of no external force and no damping is obtained as follows:

$$[ M ] \{ \ddot{u} \} + [ K ] \{ u \} = 0 \qquad ( 2 )$$

It can be seen from Equation (2) that if the influence of damping is ignored, the natural frequency of the structural system only depends on the mass and stiffness of the structural system, and has nothing to do with the external excitation vibration factors. It is the inherent attribute of the structural system itself.

An expression of displacement of a free-vibration system can be expressed as follows:

$$\{ u ( t ) \} = \{ ϕ \} sin ( ω t + θ ) \qquad ( 3 )$$

Where, {ϕ} is a shape of the vibration of the free-vibration system, which does not change with time t; θ is a phase angle; w is a frequency of the dry-mode free-vibration system.

Taking the second derivative of Equation (3), obtaining the acceleration of the free vibration:

$$\{ \ddot{u} ( t ) \} = - {ω}^{2} \{ ϕ \} sin ( ω t + θ ) = - {ω}^{2} \{ u ( t ) \} \qquad ( 4 )$$

Substituting Equations (4) and (3) into Equation (2), obtaining:

$$( [ K ] - {ω}^{2} [ M ] ) \{ ϕ \} = \{ 0 \} \qquad ( 5 )$$

Equation (5) has a nonzero solution if:

$$\vert [ K ] - {ω}^{2} [ M ] \vert = 0 \qquad ( 6 )$$

Equation (6) is the equation of the frequency of the free-vibration system. Expanding the determinant of a system with N degrees of freedom can obtain an N-order algebraic equation of a frequency parameter ω². Therefore, N roots of ω² can be obtained and can be arranged from small to large corresponding to the N frequencies (ω₁, ω₂, . . . , ω_{N}) of the system, and the corresponding serial number is the order of vibration mode (modal order) of the natural frequency. There are also N vibration modes ({ϕ}₁, {ϕ}₂, . . . , {ϕ}_{N}) corresponding thereto.

The natural mode of vibration (self-vibration mode) corresponding to the order of the corresponding natural frequency is:

$${\{ ϕ \}}_{j} = {\{ \begin{matrix}{ϕ}_{1 j} & {ϕ}_{2 j} & ⋯ & {ϕ}_{Nj}\end{matrix} \}}^{T} ( i = 1 , 2 , ⋯ , N ) \qquad ( 7 )$$

Where, in the parameter of ϕᵢⱼ, the first subscript i denotes the degree of freedom and the second subscript j denotes the number of the order of the vibration mode. The vibration mode from order 1 to order N can be written as:

$$[ ϕ ] = [ \begin{matrix}{ϕ}_{11} & {ϕ}_{12} & ⋯ & {ϕ}_{1 N} \\ {ϕ}_{21} & {ϕ}_{22} & ⋯ & {ϕ}_{2 N} \\ ⋮ & ⋮ & & ⋮ \\ {ϕ}_{N 1} & {ϕ}_{N 2} & ⋯ & {ϕ}_{NN}\end{matrix} ] \qquad ( 8 )$$

Equation (8) is called a modal matrix of vibration or modal matrix of the free-vibration system.

### 2. Calculations of the Wet Mode

Wet mode considers the influence of fluid in the form of additional mass, in which the additional mass is characteristic of structure-flow-coupled vibration system, and is a fluid force reacting on structure caused by flow field change caused by structure vibration, and also is caused by the fluid inertia. The most significant effect of the additional mass on structural modes is that the natural frequencies of structures decrease greatly with the increase of the additional mass.

By considering the influence of fluid, the equation of the free vibration of the system under the condition of no external force and no damping is changed into:

$$[ M + m ] \{ {\ddot{u}}_{w} \} + [ K + k ] \{ {u}_{w} \} = 0 \qquad ( 9 )$$

Where, [m] and [k] are the additional mass and additional stiffness of the structure due to the fluid, respectively, where subscript “w” indicates the wet mode, being distinguished from the dry mode.

With the same procedure of solving the dry mode, the n natural frequencies and corresponding n vibration modes of the structure can be obtained after considering the influence of fluid.

An expression of displacement of the free-vibration system under the wet mode can be expressed as:

$$\{ {u}_{w} ( t ) \} = \{ {ϕ}_{w} \} sin ( {ω}_{w} t + {θ}_{w} ) \qquad ( 10 )$$

Where, {ϕ_{w}} denotes the vibration shape of the wet-modal free-vibration system, which does not change with time t; θ_{w} is the phase angle of vibration of the wet-modal free-vibration system.

Taking the second derivative of Equation (10), obtaining the acceleration of the wet-modal free vibration as:

$$\{ {\ddot{u}}_{w} ( t ) \} = - {ω}_{w}^{2} \{ {ϕ}_{w} \} sin ( {ω}_{w} t + {θ}_{w} ) = - {ω}_{w}^{2} \{ {u}_{w} ( t ) \} \qquad ( 11 )$$

Substituting Equations (11) and (10) into Equation (9), obtaining:

$$( [ K + k ] - {ω}_{w}^{2} [ M + m ] ) \{ {ϕ}_{w} \} = \{ 0 \} \qquad ( 12 )$$

Equation (12) has a nonzero solution if:

$$\vert [ K + k ] - {ω}_{w}^{2} [ M + m ] \vert = 0 \qquad ( 13 )$$

Equation (13) is the equation of the frequency of the wet-modal free-vibration system. Expanding the determinant of a system with n degrees of freedom can obtain an n-order algebraic equation of a frequency parameter

$${ω}_{w}^{2}$$

Therefore, n roots of

$${ω}_{w}^{2}$$

can be obtained and are arranged from small to large corresponding to the n frequencies (ω_{w1}, ω_{w2}, . . . , ω_{wn}) of the system. The corresponding serial number is the order of vibration mode (modal order) of the natural frequency of the wet mode. There are also n wet-modal vibration modes ({ϕ_{w}}₁, {ϕ_{w}}₂, . . . , {ϕ_{w}}ₙ).

The natural mode of vibration of wet mode (self-vibration mode of wet mode) corresponding to the order of the corresponding wet-modal natural frequency is:

$${\{ {ϕ}_{w} \}}_{j} = {\{ \begin{matrix}{ϕ}_{w 1 j} & {ϕ}_{w 2 j} … {ϕ}_{wnj}\end{matrix} \}}^{T} ( j = 1 , 2 , … , n ) \qquad ( 14 )$$

Where, in the parameter ϕ_{wij}, the subscript i denotes the degree of freedom and the subscript j denotes the number of the order of the vibration mode of the wet mode shape order. Writing the vibration mode from order 1 to order n as:

$$[ {ϕ}_{w} ] = [ \begin{matrix}{ϕ}_{w 11} & {ϕ}_{w 12} & … & {ϕ}_{w 1 n} \\ {ϕ}_{w 21} & {ϕ}_{w 22} & … & {ϕ}_{w 2 n} \\ ⋮ & ⋮ & & ⋮ \\ {ϕ}_{wn 1} & {ϕ}_{wn 2} & … & {ϕ}_{wnn}\end{matrix} ] \qquad ( 15 )$$

Equation (15) is called a modal matrix of vibration or modal matrix of the wet-modal free-vibration system.

By acquiring the time-history curve of the acceleration of the bridge pier under the action of water flow, the maximum, minimum and root mean square values of the acceleration of the vibration of the bridge pier are obtained through statistical analysis of random data, and the distribution state of an acceleration energy of the vibration in frequency domain, namely power spectrum curve, is obtained and processed.

When it is judged that the FIV protection device needs to be adjusted, specially, the hydraulic rod is pressed to change the relative position of the different polyurethane boards, for example, to make the polyurethane boards extend or retract, so as to disturb the FIV of the bridge pier caused by the water flow. If the pulsation and fluctuation of seawater are too large, exceeding the restoring damping force of the energy-dissipation springs, and the energy-dissipation springs are difficult to recover, the damping of the hydraulic rod can be increased to assist the energy-dissipation springs to recover, so as to resist the pulsation and fluctuation of seawater, and make the bridge pier in a relatively stable state.

The digital twin system of the FIV protection for the bridge pier mainly comprises four parts: the physical bridge pier and its surrounding water-flow environment, a virtual model of the bridge pier and the surrounding water-flow environment thereof, the bridge-pier FIV protection processing system, and driving data of the bridge-pier FIV protection.

The physical bridge pier and its surrounding water-flow environment comprise the bridge-pier FIV protection device, the bridge pier and the surrounding water environment.

The virtual model of the bridge pier and the surrounding water-flow environment of the bridge pier is constructed by using, but not limited to, a 3D laser scanner, design drawings, and a current meter on the physical bridge pier. Uploading point cloud data of the bridge pier scanned by the 3D laser scanner to a bridge-pier FIV protection processing system located in the cloud, and performing noise removal, simplification and smoothing processing on the point cloud data through 3D point cloud editing software including but not limited to Germanic Spark, so as to encapsulate the complete point cloud data into a smooth solid model with clear outline. Importing the model generated by the point cloud into finite element software including but not limited to abaqus, dividing each part of the model, assigning material attributes to the divided parts, and then assembling each part. Setting up an interaction between each of the parts, then setting boundary conditions, gridding the each of the parts, and then generating a complete virtual model.

In the present example, judging whether to replace the FIV protection device according to the acquired state parameters of the FIV protection device, specifically comprising:
Step 2-3, inputting the acquired magnitude and direction of the displacement and the force situation of the FIV protection device into a trained surrogate model to obtain the stress situation of the structure to be protected;
step 2-4, judging whether to replace the FIV protection device according to the obtained stress situation;
Wherein, the training of the surrogate model specifically comprises the following steps of: acquiring multiple groups of mapping data of simulation of the FIV protection device and the structure to be protected based on the digital twin, and training the surrogate model with the obtained multiple groups of mapping data to obtain a trained surrogate model; wherein, the mapping data comprises the magnitude and direction of the displacement and the force situation of the FIV protection device and the stress situation corresponding to the structure to be protected.

In the present example, the displacement u_{ye} and the direction α_{ye} of the hydraulic rod of the FIV protection device and the force f_{load} received by the each polyurethane board are used as inputs to replace the role of difficult detection and input of the fluid force, finite element calculation is carried out for the working conditions of different displacement and direction of the hydraulic rod and the force magnitude of the polyurethane board, and in order to reduce the calculation amount under different displacement working conditions, the coordinate values and strains of 200 grid nodes are extracted by using a Latin hypercube sampling method; modifying, by using Bayesian time-domain, results of the generated finite element model by calculation, to make the results obtained by the finite element calculation more accurate.

In the present example, based on the finite element calculation, the multiple groups of mapping data under different working conditions, namely the displacement and direction of the hydraulic rod and the force received by each polyurethane board, and strain conditions of corresponding bridge piers are obtained; however, due to slow calculation speed of the finite element calculation, in the present example, the mapping data under different working conditions, namely the displacement and direction of the hydraulic rod and the force received by the each polyurethane board, obtained by the finite element calculation, and the corresponding stress situations are used for training the surrogate model. In the monitoring process of the FIV protection system, the surrogate model is used to replace the finite element calculation, and the stress situations of the bridge piers can be obtained in real time, which are used to perform the monitoring and warning.

Training the surrogate model by performing the Gaussian process regression on stress values obtained by the finite element calculation and input hyper-parameters, and the specific steps are as follows:

Setting 100 nodes as a training set, 100 nodes as a testing set, wherein input data for the training set are:

$$X = {\{ {x}_{n}^{D} \}}_{n = 1}^{{N}_{j}} = {[ \begin{matrix}{x}_{{1}_{j}}^{1} & {x}_{{1}_{j}}^{2} & … & {x}_{{1}_{j}}^{D} \\ {x}_{{2}_{j}}^{1} & {x}_{{2}_{j}}^{2} & … & {x}_{{2}_{j}}^{D} \\ ⋮ & ⋮ & ⋮ & ⋮ \\ {x}_{{N}_{j}}^{1} & {x}_{{N}_{j}}^{2} & … & {x}_{{N}_{j}}^{D}\end{matrix} ]}^{T} \qquad ( 16 )$$

Where, X is a vector set of the input data, D is a dimension of the input data, i.e. the number of parameters; in the present example, the number of parameters is 3, i.e. the displacement and direction of the hydraulic rod and the force received by each the polyurethane board, so D is equal to 3; N is the number of vectors, j refers to the j^{th} working condition, and the subscript in the bottom right corner refers to the quantity; in the j^{th} working condition, x₁ⱼ is a three-dimensional (3D) vector at the first node of the j^{th} working condition, and x₂ⱼ is a 3D vector at the second node of the j^{th} working condition, and so on.

For each different working condition, extracting 200 different nodes, and taking 100 of them as the training set, so Nⱼ is equal to 100, wherein j is a vector set of the data under the j^{th} operating condition.

An output data is:

$$Y = {[ {y}_{n} ]}_{n = 1}^{{N}_{j}} = {[ \begin{matrix}{y}_{1} & {y}_{2} & … & {y}_{{N}_{j}}\end{matrix} ]}^{T} \qquad ( 17 )$$

Where, Y is a vector set of the output data, N, is equal to the number of vectors of the input data, i.e. 100, and the output data y is a magnitude of stress.

A relationship between the training set and the testing set satisfies as:

$$[ \begin{matrix}Y \\ {f}_{*}\end{matrix} ] ∼ GP ( [ \begin{matrix}E ( X ) \\ E ( {X}_{*} )\end{matrix} ] , [ \begin{matrix}K ( X , X ) + {σ}_{noise}^{2} {I}_{N} & K ( X , {X}_{*} ) \\ K ( {X}_{*} , X ) & K ( {X}_{*} , {X}_{*} )\end{matrix} ] ) \qquad ( 18 )$$

$$K ( X , {X}^{′} ) = cov ( X , {X}^{′} ) = {σ}_{F}^{2} exp ( - \frac{1}{2 {l}_{F}} {( X - {X}^{′} )}^{T} ( X - {X}^{′} ) ) \qquad ( 19 )$$

Where, f_{*} is the stress set of the testing set, E(X) is the mean of the input data of the training set, K(X, X′) is the covariance matrix of X and X′, and is also a kernel function. Here, a radial basis function is employed, wherein

$${σ}_{F}^{2}$$

and l_{F} are the hyper-parameters, which respectively describe the variation amplitude of the function on the ordinate and the scaling factor of the function on the abscissa. Usually, the actual data contains a certain amount of noise, wherein the noise satisfies a Gaussian distribution with zero mean anu variance of

$${σ}_{n o ise}^{2} ,$$

and I_{N} is an Nⱼ-dimensional unit matrix.

A distribution of predicted values can be obtained as follows:

$${f}_{*} \vert {X}_{*} , X , Y ∼ GP ( \overline{{f}_{*}} , cov ( \overline{{f}_{*}} ) ) \qquad ( 20 )$$

Where, f̅_{*} is the mean function, cov(f̅_{*}) is the covariance function, X_{*} is the vector set of the input data of the testing set, X is the vector set of the input data of the training set, Y and is the vector set of the output data of the training set.

$$\overline{{f}_{*}} = E ( {X}_{*} ) + {K ( {X}_{*} , X ) [ K ( X , X ) + {σ}_{n o i s e}^{2} {I}_{N} ]}^{- 1} ( Y - m ( X ) ) \qquad ( 21 )$$

$$cov ( \overline{{f}_{*}} ) = K ( {X}_{*} , {X}_{*} ) - {K ( {X}_{*} , X ) [ K ( X , X ) + {σ}_{n o i s e}^{2} {I}_{N} ]}^{- 1} K ( X , {X}_{*} ) \qquad ( 22 )$$

A density function of f_{*} is:

$$p ( {f}_{*} \vert {X}_{*} , X , Y ) = \frac{1}{{( 2 π )}^{{N}_{j} / 2}} \frac{1}{{\vert cov ( \overline{{f}_{*}} ) \vert}^{1 / 2}} exp \{ - \frac{1}{2} {( {f}_{*} - \overline{{f}_{*}} )}^{T} cov ( \overline{{f}_{*}} ) ( {f}_{*} - \overline{{f}_{*}} ) \} \qquad ( 23 )$$

The hyper-parameters of the surrogate model are

$$θ = \{ {u}_{ye} , {α}_{ye} , {f}_{l oad} , {σ}_{n o ise}^{2} , {σ}_{F}^{2} , {l}_{F} \} ,$$

first constructing a log-likelihood function:

$$L = log p ( Y \vert X , θ ) = - \frac{1}{2} log \vert cov ( \overline{{f}_{*}} ) \vert - \frac{1}{2} {( {f}_{*} - \overline{{f}_{*}} )}^{T} cov ( \overline{{f}_{*}} ) ( {f}_{*} - \overline{{f}_{*}} ) - \frac{N}{2} log ( 2 π ) \qquad ( 24 )$$

Partial derivatives thereof are:

$$\frac{\partial L}{\partial {θ}_{\overline{{f}_{*}}}} = - \frac{1}{2} {( {f}_{*} - \overline{{f}_{*}} )}^{T} cov {( \overline{{f}_{*}} )}^{- 1} \frac{\partial \overline{{f}_{*}}}{\partial {θ}_{\overline{{f}_{*}}}} \qquad ( 25 )$$

$$\frac{\partial L}{\partial {θ}_{cov ( \overline{{f}_{*}} )}} = \frac{1}{2} ( {cov ( \overline{{f}_{*}} )}^{- 1} \frac{\partial cov ( \overline{{f}_{*}} )}{\partial {θ}_{c ov ( \overline{{f}_{*}} )}} ) + \frac{1}{2} {( {f}_{*} - \overline{{f}_{*}} )}^{T} \frac{\partial cov ( \overline{{f}_{*}} )}{\partial {θ}_{c ov ( \overline{{f}_{*}} )}} cov {( \overline{{f}_{*}} )}^{- 1} \frac{\partial cov ( \overline{{f}_{*}} )}{\partial {θ}_{c ov ( \overline{{f}_{*}} )}} ( {f}_{*} - \overline{{f}_{*}} ) \qquad ( 26 )$$

Where, θ_{f̅}_{_{*}} and θ_{cov(f̅}_{_{*}}₎ denote respectively the hyper-parameters of mean and covariance, and can be solved by minimizing L in combination with conjugate gradient descent method to obtain a well-trained surrogate model.

The FIV protection processing system continuously monitors the displacement u_{ye} and direction α_{ye} of the hydraulic rod of the FIV protection device and the force f_{load} received by the each polyurethane board, and continuously inputs them into the trained surrogate model to generate the stress situation of the bridge pier in real time. The stress situation can be converted into strain situation through mechanical calculation, and the stress and strain situations under the different working conditions will be saved in the cloud database.

Continuing to perform the finite element calculation on the working conditions calculated by the surrogate model by using a reduced order model, so as to correct the results of the surrogate model and store them in the cloud database. If the same working condition is encountered later, the result will be called directly. If a difference between the finite element calculation result and the surrogate model exceed 10%, the working condition is selected again, to re-train the surrogate model.

At the same time, the time-history curve of acceleration transmitted by the acceleration sensors are processed to obtain a power spectrum curve, the bridge-pier FIV protection processing system monitors the health state of the bridge pier in real time through three aspects of the stress, the strain and the power spectrum curve calculated by the surrogate model, and an early warning system is provided to: if the stress and strain reach 80% of the limit stress and limit strain, initiate a third-level alarm; if the stress and strain reach 90% of the limit stress and limit strain, initiate a second-level alarm; and, if the stress and strain reach 100% of the limit stress and strain, initiate a first-level alarm. The main frequency of the bridge-pier vibration response is compared with the each order of the natural frequencies of the bridge pier itself in dry and wet modes. If the main frequency obtained by monitoring is close to or the same as the natural frequency of the bridge pier, the bridge pier will resonate and damage is likely to occur. At this time, the first-level alarm will be initiated.

The stress, strain and power spectrum curves of bridge piers at different times are stored in the database, and the bridge pier FIV protection system can trace and predict the stress, strain and time-history curves of acceleration of bridge piers in service life cycle. Artificial intelligence technology may be used to mine the data, calculate the working conditions where the bridge pier is most likely to resonate, and provide reinforcement or improvement decisions for users. The data obtained by calculation and the data obtained by the monitoring of the acceleration sensors are the driving data of bridge-pier FIV protection. All the data and calculation results can be displayed in a visualization panel. A front-end design of the visualization panel is carried out through HTML, CSS and JS, and at a back-end, the data is transmitted and processed through the bridge pier FIV protection processing system based on Python in a Flask framework.

By arranging the bridge-pier FIV protection device on the bridge pier, the time-history curve of acceleration can be obtained by the acceleration sensor and transmitted to the digital twin system through the wireless data transmission module, then the power spectrum of the bridge pier can be obtained by processing the time-history curve of the acceleration by fast Fourier transform; the power spectrum is compared with the dry-wet modal characteristics of the bridge pier calculated by the digital twin system to monitor whether the bridge pier generates random resonance with the water flow. The device also realizes active and passive protection of the FIV of the bridge pier through self-power supply, achieves the purpose of energy saving and carbon reduction, improves the data model by increasing the database along with time, actively adjusts the damping size of the FIV protection device through a digital twin system, reduces fatigue damage of the bridge pier under the action of water flow, and avoids the danger of resonance of bridge piers with water flow. In case of ship collision danger, the bridge-pier FIV protection device can be adjusted manually or automatically to weaken the ship collision load or directly change the ship's running direction. The solution of the present example has a reliable effect on the FIV protection of the bridge pier, explores a development direction of the FIV protection of the bridge pier, and is expected to have a wide application prospect in the engineering field.

### Example 3

The present example provides a FIV protection system, comprising:
an acquisition module, configured to: acquire state parameters of a FIV protection device, wherein the state parameters comprise magnitude and direction of displacement, force situation and acceleration; and
a judgment module, configured to: judge whether to adjust or replace the FIV protection device according to the acquired state parameters of the FIV protection device.

Those skilled in the art will appreciate that the various modules or steps of the invention described above may be implemented using general purpose computer means, alternatively they may be implemented using program code executable by computing means such that they may be stored in memory means for execution by computing means, or fabricated separately as individual integrated circuit modules, or multiple of them may be fabricated as a single integrated circuit module. The present invention is not limited to any particular combination of hardware and software.

Although the specific embodiments of the present invention are described above in combination with the accompanying drawings, it is not a limitation on the protection scope of the present invention. Those skilled in the art should understand that on the basis of the technical scheme of the present invention, various modifications or deformations that can be made by those skilled in the art without creative labor are still within the protection scope of the present invention.

1. A method for monitoring bridge piers based on digital twin, using a flow-induced vibration (FIV) protection device, wherein the FIV protection device comprises: an annular steel board and a plurality of polyurethane boards, wherein an inner wall of the annular steel board is fixedly connected to a structure to be protected, a hydraulic device and a plurality of energy-dissipation springs are arranged between an outer wall of the annular steel board and each of the plurality of the polyurethane boards, and the plurality of the polyurethane boards are arranged at intervals;
the FIV protection device further comprises a plurality of acceleration sensors arranging on the outer wall of the annular steel board;
the method for monitoring bridge piers based on digital twin comprises:
acquiring state parameters of the FIV protection device; wherein, the state parameters comprise magnitude and direction of displacement of the hydraulic device, a force situation of the each of the plurality of the polyurethane boards and an acceleration; and
judging whether to adjust and replace the FIV protection device according to the acquired state parameters of the FIV protection device;
wherein, judging whether to replace the FIV protection device according to the acquired state parameters of the FIV protection device, specially comprises:
inputting the acquired magnitude and direction of the displacement of the hydraulic device and the force situation of the each of the plurality of the polyurethane boards of the FIV protection device into a trained surrogate model to obtain a stress situation of the structure to be protected;
judging whether to replace the FIV protection device according to the obtained stress situation;
wherein, a training of a surrogate model, specially comprises: acquiring multiple groups of mapping data of simulation of the FIV protection device and the structure to be protected based on digital twin, and training the surrogate model with the obtained multiple groups of the mapping data, to obtain the trained surrogate model; wherein, the mapping data comprises the magnitude and direction of the displacement of the hydraulic device and the force situation of the each of the plurality of the polyurethane boards of the FIV protection device, and a corresponding stress situation of the structure to be protected;
and, judging whether to perform an adjusting operation on the FIV protection device according to the acquired state parameters of the FIV protection device, specially comprises:
processing the acquired acceleration of the FIV protection device by fast Fourier transform to obtain a power spectrum; and
inputting the obtained power spectrum into a digital twin model corresponding to the structure to be protected, comparing, by the digital twin model, the power spectrum with self-vibration frequencies calculated under a dry mode and a wet mode respectively through a digital twin-body of the structure to be protected, obtaining a prediction result of whether the structure to be protected generates the FIV, and judging whether to perform the adjusting operation on the FIV protection device according to the prediction result.

2. The method for monitoring bridge piers based on digital twin according to claim 1, wherein extracting, by using a Latin hypercube sampling method, coordinate values and strain values of a plurality of grid nodes in a finite element model generated according to the FIV protection device and the structure to be protected.

3. The method for monitoring bridge piers based on digital twin according to claim 1, wherein respectively calculating the self-vibration frequencies of the structure to be protected under the dry mode and the wet mode according to the digital twin-body of the structure to be protected, specially comprises:
constructing an equation of motion of the structure to be protected;
obtaining an equation of free vibration under conditions of no external force and no damping according to the constructed equation of motion and based on damping ratio characteristics of the structure to be protected;
constructing an expression of the displacement of the structure to be protected and finding the second derivative, to obtain an acceleration of the free vibration of the structure to be protected;
substituting the constructed expression of the displacement of the structure to be protected and the acceleration of the free vibration into the equation of the free vibration, to obtain an equation of frequency; and
obtaining a self-vibration frequency under the dry mode and a self-vibration frequency under the wet mode based on the obtained equation of frequency.

4. The method for monitoring bridge piers based on digital twin according to claim 1, wherein when the adjusting operation is judged that needs to be performed on the FIV protection device, relative positional relationship between adjacent polyurethane plates is changed by applying a pressure to the hydraulic device, to alter a flow-induced vibration of the structure to be protected caused by a water flow.

5. The method for monitoring bridge piers based on digital twin according to claim 1, wherein:
when the adjusting operation is judged that needs to be performed on the FIV protection device, increasing damping of the hydraulic device to assist the energy-dissipation springs to recover.

6. A system for monitoring bridge piers based on digital twin, using a method for monitoring bridge piers based on digital twin according to claim 1, comprising:
an acquisition module, configured to: acquire state parameters of a FIV protection device, wherein the state parameters comprise magnitude and direction of the displacement of hydraulic device, force situation of each of a plurality of polyurethane boards, and acceleration; and
a judgment module, configured to: judge whether to adjust and replace the FIV protection device according to the acquired state parameters of the FIV protection device.
